(19) United States
(12) Patent Application Publication
(10) Pub. No.: US 2020/0037066 A1
(43) Pub. Date: Jan. 30, 2020

(54) SOUND ABSORBING MATERIAL AND SPEAKER USING SAME

(71) Applicant: AAC ACOUSTIC TECHNOLOGIES (SHENZHEN) CO., LTD., Shenzhen (CN)

(72) Inventors: Hongshu Feng, Shenzhen (CN); Hezhi Wang, Shenzhen (CN); Kun Tang, Shenzhen (CN); Jiqiang Dai, Shenzhen (CN)

(21) Appl. No.: 16/522,697

(22) Filed: Jul. 26, 2019

(30) Foreign Application Priority Data
Jul. 28, 2018 (CN) 201810849799.X

(51) Int. Cl. H04R 1/28; C01B 39/06; C01B 39/04

(52) U.S. Cl. CPC H04R 1/2876; G10K 11/165; C01B 39/04; C01B 39/06

(57) ABSTRACT

The present disclosure provides a sound absorbing material. The sound absorbing material comprises MEL-structural-type molecular sieves, the MEL-structural-type molecular sieves comprising frameworks and extra-framework cations, the frameworks comprising silica and an oxide MxOy containing an element M which is a non-silicon element; wherein a mass ratio of Si to M in the framework is at least 80, the extra-framework cations comprise at least one of hydrogen ions, alkali metal ions, alkaline earth metal ions and transition metal ions, and a content of the extra-framework cations is between 0.05 wt % and 1.5 wt %.

### FIELD OF THE DISCLOSURE

The present disclosure relates to a sound absorbing material, and more particularly to a sound absorbing material applied in speaker and a speaker using the same.

### DESCRIPTION OF RELATED ART

With the development of science and technology, people are imposing higher and higher requirements on speakers, especially speakers for mobile phones. It is not only required that the speaker is small in size and produces sound, but also required that the speaker provide a better sound quality. The sound quality is related to design and stages in manufacture of the speaker, especially a designed volume of the posterior cavity of the speaker. Generally, reduction of the posterior of the speaker may remarkably degrade responses in low-frequency bands, and thus the sound quality becomes poorer. Therefore, it is difficult to provide a better sound quality with a small posterior cavity.

To address the above technical problem, generally the following approaches are available: 1. the air in the posterior cavity is replaced with a gas with better acoustic compliance; 2. filling foams similar to melamine or the like into the posterior cavity to enhance the acoustic compliance; 3. filling active carbon, zeolite, silica or the like porous material to enhance a virtual volume of the posterior cavity and improve the acoustic compliance. Among these approaches, the third approach achieves a most apparent effect.

In the related art, the zeolite structure mainly includes FER, MFI, BEA and MEL. Frameworks of MEL-structural-type molecular sieves are mainly formed of silica and alumina. If a mass ratio of Si to Al is less than 80, the frameworks may remarkably absorb moisture in the air and occupy micropore channels of most of the molecular sieves. As a result, no low-frequency improvement effect is achieved. In addition, during synthesis using metal ions containing an element M the oxide containing the element M, if the mass ratio of Si to M is too low, the synthesis may not be completed or synthesized MEL-structure crystalline and the like is degraded or becomes poorer. However, if the mass ratio of Si to Al is too high, although the moisture absorption rate is low and an initial acoustic effect is ensured, as time elapses, the MEL-structure molecular sieves absorb trace volatile organics (VOCs) emitted by the speaker. As a result, the performance is constantly attenuated.

Therefore, it is desired to provide new and improvement sound absorbing materials and a speaker using the same to overcome the aforesaid problems.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is an XRD pattern of a MEL and MFI mixed phase molecular sieve provided in Example 1 of the present disclosure;

FIG. 2 is an XRD pattern of a pure phase MEL molecular sieve provided by Example 3 of the present disclosure;

FIG. 3 is an XRD pattern of a pure phase MFI molecular sieve provided by Comparative Example 1 of the present disclosure;

FIG. 4 is a comparison diagram of low temperature nitrogen adsorption of Example 1, Example 2 and Example 4 of the present disclosure;

FIG. 5 is a comparison diagram of low temperature nitrogen adsorption of Comparative Example 1 and Comparative Example 2 of the present disclosure;

FIG. 6 is a comparison diagram of atmospheric temperature nitrogen adsorption of Example 1 of the present disclosure and Comparative Example 1;

FIG. 7 is a comparison diagram of a frequency response curve and an impedance curve of a speaker posterior cavity with and without a MEL molecular sieve; and

FIG. 8 is a schematic structural view of a speaker provided by the present disclosure.

### DETAILED DESCRIPTION

The present disclosure will be hereinafter described in detail below with reference to the attached drawings and embodiments thereof.

The present disclosure relates to a sound absorbing material, wherein the sound absorbing material includes MEL-structural-type molecular sieves. The MEL-structural-type molecular sieves include frameworks and extra-framework cations, wherein the frameworks include slilca (SiO2) and oxide MxOy containing an element M which is a non-silicon element, and a mass ratio of Si to M in the framework is at least 80.

It should be noted that, through experiments, it is revealed that the frameworks of the MEL-structural-type molecular sieves are mainly formed of silica and alumina, and if a mass ratio of Si to Al is less than 80, the frameworks may remarkably absorb moisture in the air and occupy micropore channels of most of the molecular sieves. As a result, no low-frequency improvement effect is achieved. In addition, during synthesis using the oxide containing the element M, if the mass ratio of Si to M is too low, the synthesis may not be completed or synthesized MEL-structural-type crystalline and the like is degraded or becomes poorer. If the mass ratio of Si to Al is too high, although the moisture absorption rate is low and an initial acoustic effect is ensured, as time elapses, the MEL-structural-type molecular sieves absorb volatile organics (VOCs) emitted by the speaker. As a result, the performance is constantly attenuated.

Therefore, in this embodiment, the mass ratio of Si to M is preferably between 150 and 2000, more preferably between 150 and 1500, and further more preferably between 200 and 1000, such that water resistance of the MEL-structural-type molecular sieves is remarkably improved, the low-frequency improvement effect is better, and the synthesis difficulty is lowered and the crystalline is bettered. In addition, VOCs resistance and performance attenuation resistance of the low-frequency sound absorbing material is notably enhanced.

The extra-framework cations include at leas one of hydrogen ions, alkali metal ions, alkaline earth metal ions or transition metal ions, and a content of the extra-framework cations is between 0.05 wt % and 1.5 wt %, preferably between 0.1 wt % and 1.0 wt %, and more preferably between 0.15 wt % and 0.8 wt %. In this embodiment, the extra-framework cations are preferably at least one of alkali metal ions or alkaline earth metal ions. Specifically, the extra-framework cations include at least one of lithium ions, sodium ions, potassium ions, barium ions, calcium ions, magnesium ions, copper ions, zinc ions or silver ions. Nevertheless, the extra-framework cations are not limited to these ions. The extra-framework cations effectively improve stability of the molecular sieves, such that long-term stability of the speaker using the sound absorbing material is improved.

Specifically, the element M is preferably aluminum (Al), the oxide containing the element M is totally or partially an oxide of aluminum, the mass ratio of Si to Al of the MEL-structural-type molecular sieves is preferably between 200 and 400 (exclusive of 400), or preferably between 400 and 1000. The higher the mass ratio of Si to Al, the better the acoustic performance of the speaker filled with the MEL-structural-type molecular sieves in the low frequency band.

Further, the element M further includes trivalent metal ions and/or tetravalent metal ions besides aluminum. In this embodiment, the trivalent metal ions and/or the tetravalent metal ions further include at least one of iron (Fe) ions, boron (B) ions, titanium (Ti) ions, zirconium (Zr) ions, gallium (Ga) ions, chromium (Cr) ions or molybdenum (Mo) ions. A person skilled in the art may understand that categories of the trivalent metal ions and the tetravalent metal ions are not limited to the above listed examples, and may be other metal ions, which do not affect the effect of the present disclosure.

It should be noted that in this embodiment, a particle size of the MEL-structural-type molecular sieves is between 10 nm and 10 μm, preferably between 30 nm and 6 μm, and more preferably between 40 nm and 5 μm. Further, the particle size of the MEL-structural-type molecular sieves is a 500-nanometer to 5-micrometer conventional synthesis micrometer-scale particle size or a 40-nanometer to 500-nanometer non-conventional synthesis micrometer-scale particle size. Since the MEL-structural-type molecular sieves have a smaller particle size, during practical use, the MEL-structural-type molecular sieves need to be used together with a binder to mold greater particles which are suitable to be used as the sound absorbing material.

It should be noted that in this embodiment, the molecular sieves may be pure-phase MEL-structural-typed molecular sieves. Since the pure-phase molecular sieves have a high purity, speaker box with a posterior cavity filled with the MEL-structural-type molecular sieves achieves a better acoustic performance in the low frequency band. In addition, the molecular sieves may also be mixed-phase MEL-structural-type molecular sieves, and preferably MEL and MEL mixed-phase-structure molecular sieves. The mixed-phase MEL-structural-type molecular sieves do not affect the effect of the present disclosure.

The present disclosure further provides a preparation method of the above sound absorbing material.

In step 1, MEL-structural-type molecular sieves with a mass ratio of a silicon element to an element M being between 150 and 2000 are synthesized using a silicon source, an alkali source, a template, an M source and water.

With respect to step 1, specifically, the M source is a source of the element M (that is, a non-silicon element), and the starting materials (the silicon source, the M source, the template, the alkali source and the like) for synthesis were added to a synthesis reactor, and MLE-structure molecular sieve powder was obtained through a crystallization reaction. The crystallization reaction is typically carried out in an aqueous phase for a specific time duration, also referred to as a hydrothermal reaction. The hydrothermal reaction is typically carried out at a temperature in the range of between the room temperature and 250° C., preferably in the range of between the room temperature and 150° C., and the hydrothermal reaction is typically carried out under a pressure which is produced by a solvent with changes of the temperature thereof.

It should be noted that in this embodiment, the silicon source includes at least one of tetraethylorthosilicate, silica sol or sodium silicate; the M source includes at least one of an oxide of the element M, an inorganic salt of the element M or an organic salt of the element M; and the alkali source includes at least one of sodium hydroxide, potassium hydroxide, lithium hydroxide or organic alkali; and the template includes at least one of an ammonium salt, an alkali metal salt or an alkaline earth metal salt.

In step 2, the synthesized MEL-structural-type molecular sieves are separated by a centrifuge and washed, and the MEL-structural-type molecular sieves are roasted to remove the template.

With respect to step 2, specifically, the specific time duration is a hydrothermal reaction duration, wherein the hydrothermal reaction duration is typically half an hour to several months according to the actual conditions, preferably 4 h to 240 h; and the particle size of the MEL-structural-type molecular sieves experiencing the hydrothermal reaction is controlled to be between 5 nm to 20 μm, preferably between 10 nm and 10 μm; and a temperature for roasting is between 350° C. and 850° C., preferably between 500° C. and 700° C.

In step 3, the MEL-structural-type molecular sieves are molded with a binder and a solvent and an auxiliary to shaped particles having a specific particle size.

With respect to step 3, specifically, since the particle size of the MEL-structural-type molecular sieves molded in step 2 is too small, if the MEL-structural-type molecular sieves are directly filled into the posterior cavity of the speaker as the sound absorbing material, the MEL-structural-type molecular sieves may be apt to leak outside the filling region, thereby affecting normal use of the speaker. Therefore, in step 3, the binder is added to the MEL-structural-type molecular sieves to mold shaped particles which are suitable to be used as the sound absorbing material.

The “specific particle size” signifies that the particle size of the shaped particles upon the molding (that is, molding of the sound absorbing material) is between 10 μm and 100 μm, preferably between 20 μm and 600 μm, and more preferably between 25 μm and 500 μm. Upon molding of the sound absorbing material, when the sound absorbing material is applied to the speaker box, the multi-particle sound absorbing material is filled into the speaker box.

The binder mainly includes an inorganic binder and an organic polymer binder. The inorganic binder may be an active aluminum oxide, a silica sol or the like; and the organic polymer binder may be an acrylate binder, an epoxy binder, a polyurethane binder or the like. The solvent mainly includes water and various commonly used organic solvents, for example, ethanol, toluene, acetone, tetrahydrofuran or the like. The auxiliary refers to other substances which are added in a small amount, generally less than 5%.

It should be noted that upon step 2 and prior to step 3, a step of carrying out cation exchange for the MEL-structural-type molecular sieves may be performed, such that different forms of MEL-structural-type molecular sieves are obtained. In this step, ammonium salts, alkali metal salts or alkaline earth metal salts may be used to carry out exchange with the molecular sieves. The ammonium salts mainly include ammonium chloride, ammonium nitrate, ammonium carbonate or the like; the alkali metal salts mainly include a lithium salt, a sodium salt, a potassium salt, a rubidium salt or the like; anions of the alkali metal salts include chloride ions, sulfate ions, nitrate ions or the like; the alkaline earth metal salts mainly include a magnesium salt, a calcium salt, a barium salt or the like; and anions of the alkaline earth metal salts include chloride ions, sulfate ions, nitrate ions or the like.

### Example 1

A sound absorbing material in this embodiment includes MEL and MEI-mixed-phase structural-type molecular sieves. A preparation method of the sound absorbing material is as follows:

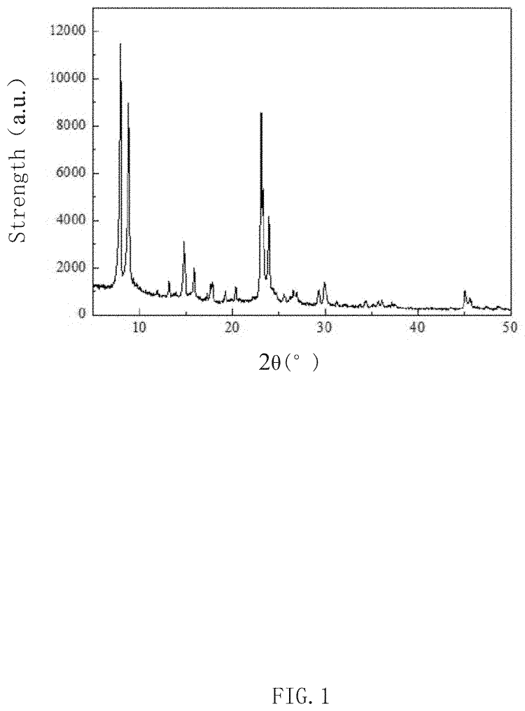

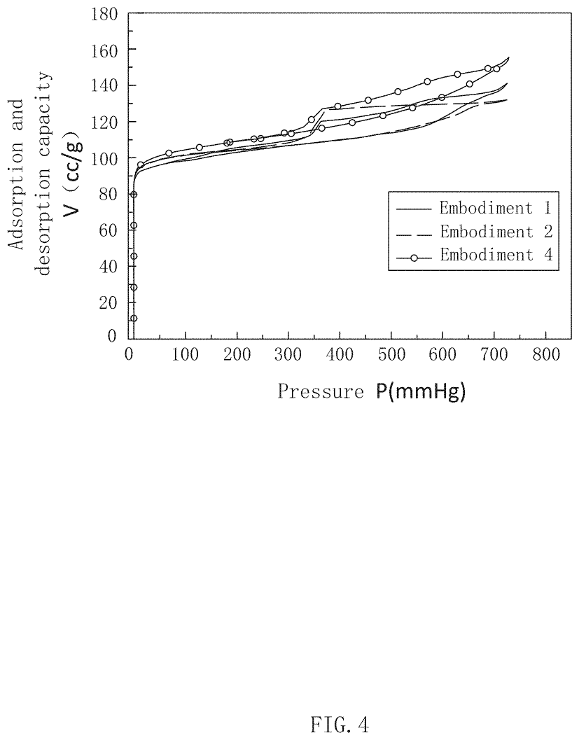

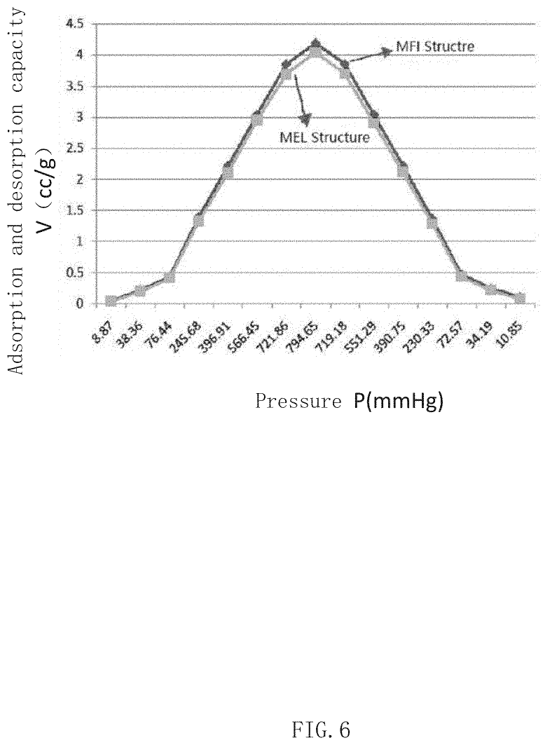

MEL and MFL-mixed-phase structural-type molecular sieves with a mass ratio of Si to Al being 250 were synthesized using a silicon source (including tetraethylorthosilicate, silica sol, sodium silicate or the like), an aluminum source (aluminum nitrate, sodium bicarbonate, aluminum isopropoxide or the like), an alkali source (sodium hydroxide, potassium hydroxide or lithium hydroxide), a tetrabutyl quaternary ammonium salt (at least one of tetrabutylammonium bromide, tetrabutylammonium hydroxide, tetrabutylammonium chloride, tetrabutylammonium iodide or tetrabutylammonium fluoride) as a template and water. FIG. 1 illustrates an XRD pattern thereof. FIG. 4 illustrates low-temperature nitrogen absorption characterization thereof, and FIG. 6 illustrates room-temperature nitrogen absorption and desorption thereof.

### Embodiment 2

A sound absorbing material in this embodiment includes MEL and MEI-mixed-phase structural-type molecular sieves. A preparation method thereof is as follows:

MEL and MFL-mixed-phase structural-type molecular sieves with a mass ratio of Si to Fe being 300 were synthesized using a silicon source (including tetraethylorthosilicate, silica sol, sodium silicate or the like), an iron source (iron nitrate, iron sulfate or iron chloride), an alkali source (sodium hydroxide, potassium hydroxide or lithium hydroxide), a tetrabutyl quaternary ammonium salt (at least one of tetrabutylammonium bromide, tetrabutylammonium hydroxide, tetrabutylammonium chloride, tetrabutylammonium iodide or tetrabutylammonium fluoride) as a template and water. Table 1 illustrates acoustic performance thereof. FIG. 4 illustrates low-temperature nitrogen absorption characterization thereof.

### Embodiment 3

The sound absorbing material in this embodiment includes pure-phase MEL-structural-type molecular sieves.

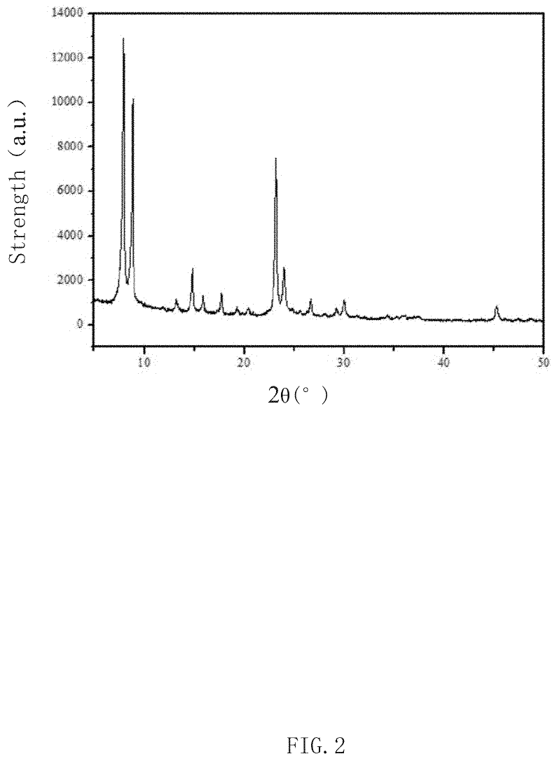

A preparation method thereof is as described in Embodiment 1. The template was a composite template formed by a tetrabutyl quaternary ammonium salt and a benzyltrimethyl quaternary ammonium salt (the categories of the quaternary ammonium salts are as described in Embodiment 1), and pure-phase MEL-structural-type molecular sieves with a mass ratio of Si to Al being 250 were synthesized. FIG. 2 illustrates an XRD pattern thereof. Table 1 illustrates acoustic performance of the pure-phase MEL-structural-type molecular sieves obtained in this embodiment.

### Embodiment 4

The sound absorbing material in this embodiment includes pure-phase MEL-structural-type molecular sieves.

A preparation method thereof is as described in Embodiment 1. The template was a composite template formed by a tetrabutyl quaternary ammonium salt and a benzyltrimethyl quaternary ammonium salt (the categories of the quaternary ammonium salts are as described in Embodiment 1), and pure-phase MEL-structural-type molecular sieves with a mass ratio of Si to Al+Ti being 150 were synthesized. FIG. 2 illustrates an XRD pattern thereof. Table 1 illustrates acoustic performance thereof. FIG. 4 illustrates low-temperature nitrogen absorption characterization thereof.

### Embodiment 5

The sound absorbing material in this embodiment includes pure-phase MEL-structural-type molecular sieves.

A preparation method thereof is as described in Embodiment 1. The template was a composite template formed by a tetrabutyl quaternary ammonium salt and a benzyltrimethyl quaternary ammonium salt (the categories of the quaternary ammonium salts are as described in Embodiment 1), and pure-phase MEL-structural-type molecular sieves with a mass ratio of Si to M being infinitely greater (the content of the element M is less than 0.05 wt %). Table 1 illustrates acoustic performance of the pure-phase MEL-structural-type molecular sieves obtained in this embodiment.

### Embodiment 6

The pure-phase MEL-structural-type molecular sieves obtained in Embodiment 3 were exchanged to a hydrogen type using an acid or an ammonium salt. The acid includes at least one of a hydrochloric acid, a sulfuric acid, a nitric acid, acetic acid, tartaric acid or the like, but is not limited to these acids; and the ammonium salt includes an ammonium chloride, an ammonium sulfate, an ammonium nitrate or the like, but is not limited to these salts.

Table 1 illustrates acoustic performance of the pure-phase MEL-structural-type molecular sieves obtained in this embodiment.

### Embodiment 7

The MEL-structural-type molecular sieves obtained in Embodiment 3 were exchanged to a lithium type using a lithium salt. The lithium salt includes at least one of lithium chloride, lithium sulfate, lithium carbonate or the like, but is not limited to these salts. Table 1 illustrates acoustic performance of the pure-phase MEL-structural-type molecular sieves obtained in this embodiment.

### Embodiment 8

The MEL-structural-type molecular sieves obtained in Embodiment 3 were exchanged to a sodium type using a sodium salt. The sodium salt includes at least one of sodium chloride, sodium sulfate, sodium nitrate or the like, but is not limited to these salts. Table 1 illustrates acoustic performance of the pure-phase MEL-structural-type molecular sieves obtained in this embodiment.

### Embodiment 9

The MEL-structural-type molecular sieves obtained in Embodiment 3 were exchanged to a potassium type using a potassium salt. The potassium salt includes at least one of potassium chloride, potassium sulfate, potassium nitrate or the like, but is not limited to these salts. Table 1 illustrates acoustic performance of the pure-phase MEL-structural-type molecular sieves obtained in this embodiment.

### Embodiment 10

The MEL-structural-type molecular sieves obtained in Embodiment 3 were exchanged to a potassium and sodium-mixed type using a potassium salt and a sodium salt together. The potassium salt and the sodium salt are as described in Embodiment 8 and Embodiment 9, but are not limited to the salts listed therein. Table 1 illustrates acoustic performance of the pure-phase MEL-structural-type molecular sieves obtained in this embodiment.

### Embodiment 11

The MEL and MFL-mixed-phase structural-type molecular sieves obtained in Embodiment 1 were exchanged to a magnesium type using a magnesium salt. The magnesium salt includes at least one of magnesium nitrate, magnesium sulfate or the like, but is not limited to these salts. Table 1 illustrates acoustic performance of the pure-phase MEL-structural-type molecular sieves obtained in this embodiment.

### Embodiment 12

The MEL and MFL-mixed-phase structural-type molecular sieves obtained in Embodiment 1 were exchanged to a magnesium and sodium-mixed type using a magnesium salt and a sodium salt together. The potassium salt and the sodium salt are as described in Embodiment 8 and Embodiment 11, but are not limited to the salts listed therein. Table 1 illustrates acoustic performance of the pure-phase MEL-structural-type molecular sieves obtained in this embodiment.

### Embodiment 13

A sound absorbing material in this embodiment includes pure-phase MEL-structural-type molecular sieves. A preparation method thereof is as follows:

Pure-phase MEL-structural-type molecular sieves with a mass ratio of Si to Al being 350 were synthesized using the method as described in Embodiment 3. Table 1 illustrates acoustic performance thereof.

### Embodiment 14

A sound absorbing material in this embodiment includes pure-phase MEL-structural-type molecular sieves. A preparation method thereof is as follows:

Pure-phase MEL-structural-type molecular sieves with a mass ratio of Si to Al being 550 were synthesized using the method as described in Embodiment 3, and then exchanged to a sodium type using a sodium salt. Table 1 illustrates acoustic performance thereof.

### Embodiment 15

A sound absorbing material in this embodiment includes pure-phase MEL-structural-type molecular sieves. A preparation method thereof is as follows:

Pure-phase MEL-structural-type molecular sieves with a mass ratio of Si to Al being 1000 were synthesized using the method as described in Embodiment 3, and then exchanged to a potassium type using a potassium salt. Table 1 illustrates acoustic performance thereof.

### Embodiment 16

A sound absorbing material in this embodiment includes pure-phase MEL-structural-type molecular sieves. A preparation method thereof is as follows:

Pure-phase MEL-structural-type molecular sieves with a mass ratio of Si to Al being 1700 were synthesized using the method as described in Embodiment 3, and then exchanged to a potassium and sodium-composite type using a potassium salt and a sodium salt. Table 1 illustrates acoustic performance thereof.

### Embodiment 17

A sound absorbing material in this embodiment includes pure-phase MEL-structural-type molecular sieves. A preparation method thereof is as follows:

Pure-phase MEL-structural-type molecular sieves with a mass ratio of Si to Al being 250 were synthesized using the method as described in Embodiment 3, and were exchanged twice and coasted twice. The pure-phase MEL-structural-type molecular sieves were exchanged using an ammonium salt and then coasted, and afterwards exchanged to a potassium type using a potassium salt. Table 1 illustrates acoustic performance thereof.

### Embodiment 18

A sound absorbing material in this embodiment includes pure-phase MEL-structural-type molecular sieves. A preparation method thereof is as follows:

Pure-phase MEL-structural-type molecular sieves with a mass ratio of Si to Al being 250 were synthesized using the method as described in Embodiment 3, and were exchanged twice and coasted twice. The pure-phase MEL-structural-type molecular sieves were exchanged using a sodium salt and then coasted, then exchanged with an ammonium salt and coasted, and finally exchanged using a sodium salt to a sodium type. Table 1 illustrates acoustic performance thereof.

### Comparative Example 1

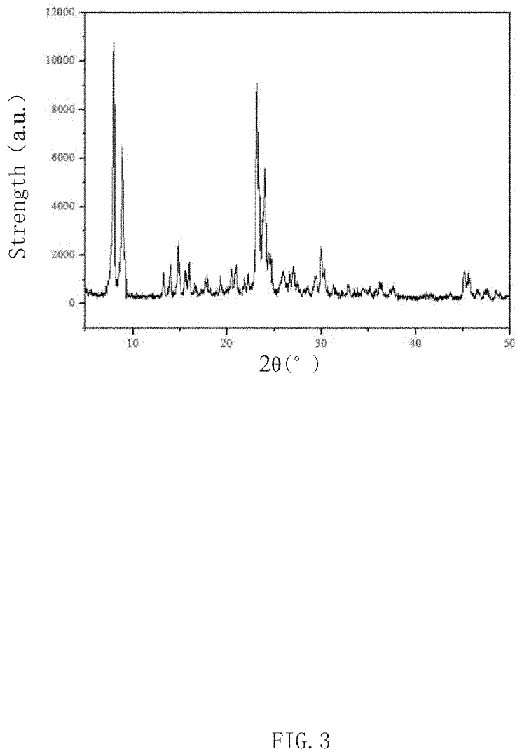

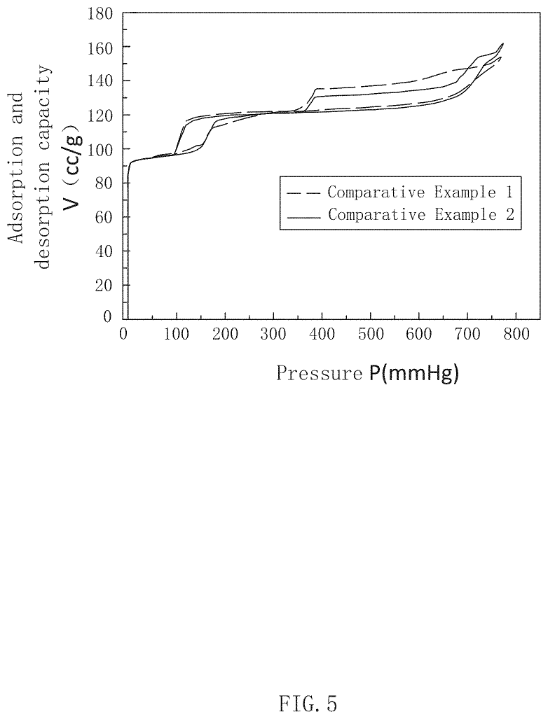

As described in Embodiment 1, MFI-structural-type molecular sieves were synthesized using a tetrapropyl quaternary ammonium salt as the template to obtain Comparative Example 1. Table 1 illustrates acoustic performance thereof. FIG. 3 illustrates an XRD pattern thereof. FIG. 5 illustrates low-temperature nitrogen absorption characterization thereof.

### Comparative Example 2

As described in Comparative Example 1, the MFI-structural-type molecular sieves were exchanged using a potassium salt to potassium-type MEI-structural-type molecular sieves to obtain Comparative Example 2. Table 1 illustrates acoustic performance thereof. FIG. 5 low-temperature nitrogen absorption characterization thereof. FIG. 6 illustrates room-temperature nitrogen absorption characterization thereof.

The molecular sieves synthesized in Embodiments 1 to 18 and Comparative Examples 1 to 2 were respectively mixed with a solvent, a binder and an auxiliary to prepare a suspension mixture. The suspension mixture was dried and pulverized to obtain particle-like molecular sieves. Afterwards, the particle-like molecular sieves were filled into the posterior cavity of the speaker (the posterior cavity has a volume of 1 cm3 upon assembling), and an acoustic performance test was carried out. Table 1 illustrates test results.

TABLE 1
Resonance frequencies F0 and Q values before and after the molecular
sieves are filled into the posterior cavity of the speaker

| | | | | | | Reduction |
|---|---|---|---|---|---|---|
| | | | | | | value with |
| | | | No molecular | 1 cc | | double- |
| | Actual | Extra- | sieve in the | molecular | | 85, 7 d |
| | Si/M | framework | posterior cavity | sieves | Reduction | attenuation |
| | (Al) | cation | of speaker | added | value | resistance |
| | mass ratio | content/wt. % | F_{0/Hz} | F_{0/Hz} | ΔF_{0/Hz} | ΔF_{0/Hz} |
| Embodiment 1 | 221 | 0.85 | 778.5 | 568.2 | 210.3 | 132 |
| Embodiment 2 | 330 | 0.68 | 777.6 | 546.6 | 231.0 | 146 |
| Embodiment 3 | 226 | 0.89 | 779.1 | 560.4 | 218.7 | 142 |
| Embodiment 4 | 240 | 0.88 | 783.2 | 552.3 | 231.9 | 147 |
| Embodiment 5 | 2700 | 0.18 | 779.1 | 566.4 | 212.7 | 34 |
| Embodiment 6 | 224 | 0.09 | 777.0 | 566.4 | 210.6 | 32 |
| Embodiment 7 | 227 | 0.24 | 779.5 | 564.1 | 215.4 | 125 |
| Embodiment 8 | 220 | 0.77 | 778.9 | 550.2 | 228.7 | 156 |
| Embodiment 9 | 219 | 0.92 | 779.7 | 543.4 | 236.3 | 157 |
| Embodiment 10 | 223 | 0.88 | 777.8 | 540.4 | 237.4 | 160 |
| Embodiment 11 | 224 | 0.56 | 779.6 | 561.3 | 218.3 | 158 |
| Embodiment 12 | 227 | 0.59 | 781.2 | 551.3 | 229.9 | 160 |
| Embodiment 13 | 330 | 0.67 | 781.5 | 550.3 | 231.2 | 191 |
| Embodiment 14 | 510 | 0.51 | 782.6 | 545.5 | 237.1 | 210 |
| Embodiment 15 | 915 | 0.48 | 780.8 | 545.0 | 235.8 | 197 |
| Embodiment 16 | 1413 | 0.39 | 781.5 | 547.1 | 234.4 | 172 |
| Embodiment 17 | 226 | 0.45 | 780.2 | 545.1 | 235.1 | 187 |
| Embodiment 18 | 221 | 0.47 | 780.8 | 547.2 | 233.6 | 188 |
| Comparative | 230 | 0.59 | 779.1 | 556.4 | 222.7 | 157 |
| Example 1 | | | | | | |
| Comparative | 231 | 0.51 | 777.0 | 546.4 | 230.6 | 161 |
| Example 2 | | | | | | |

(Remarks: Double-85, 7d attenuation resistance performance evaluation of the speaker box means that: The molded MEL-structural-type molecular sieves are filled into the posterior cavity of the speaker, a specific frequency sweep signal is applied to the speaker for constant operation, and the entire speaker is placed into an oven with constant temperature and humidity for standing 7 days at a temperature of 85° C. and a humidity of 85%.)

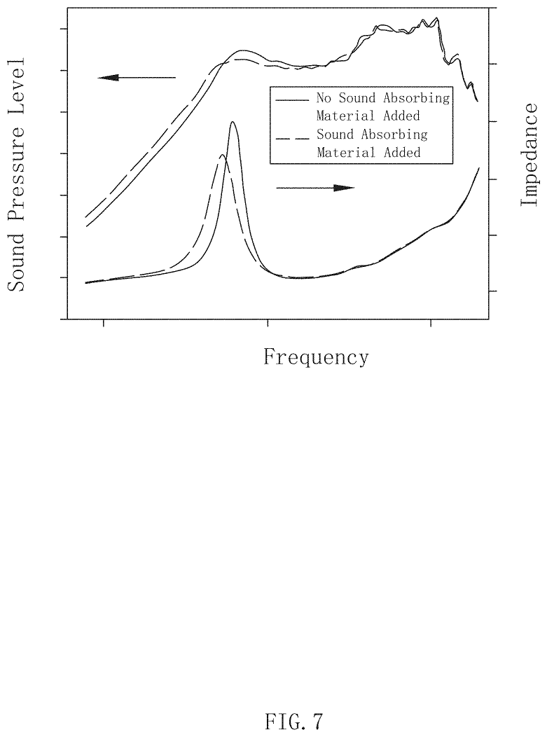

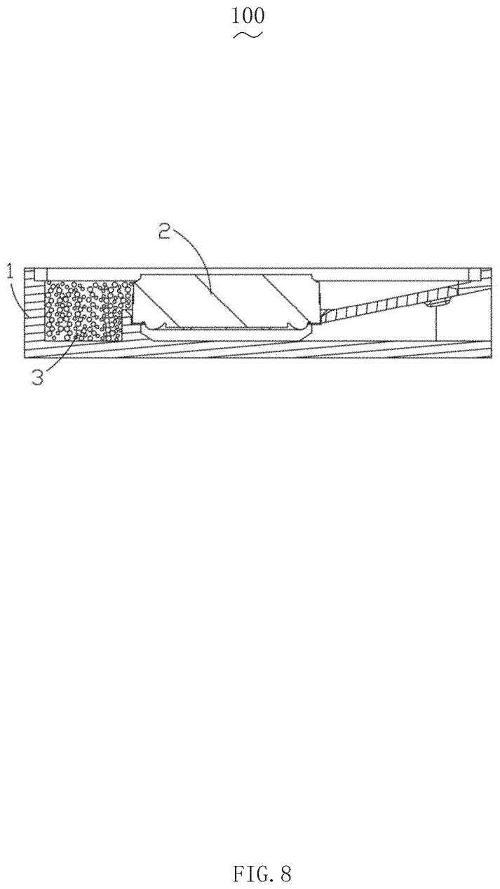

The present disclosure further provides a speaker 100. As illustrated in FIG. 8, the speaker 100 includes a housing 1 having a receiving space, a speaker 2 disposed in the housing 1 and a posterior cavity 3 defined by the speaker 2 and the housing 1. The posterior cavity 3 is filled with the above sound absorbing material to enhance acoustic compliance of the air in the posterior cavity and thus to improve low-frequency performance of the speaker. In addition, in practice, the sound absorbing material has strong performance attenuation resistance. As illustrated in FIG. 7, solid lines represent sound pressure and frequency response when the sound absorbing material is not filled, and dotted lines represent sound pressure and frequency response when the sound absorbing material is filled.

Relative to the related art, the sound absorbing material, the preparation method thereof and the speaker using the sound absorbing material according to the present disclosure achieve the following beneficial effects:

1. The sound absorbing material includes MEL-structural-type molecular sieves. Frameworks of the MEL-structural-type molecular sieves include silica which has uniform micropores. The micropores absorb and desorb air molecules under the effect of the sound pressure, and may achieve the effect of increasing a virtual volume of the acoustic cavity. When the MEL-structural-type molecular sieves are filled into the posterior cavity of the speaker, low-frequency response of the speaker may be remarkably improved, and low-frequency acoustic performance thereof is improved.

2. If the MEL-structural-type molecular sieves are used as the sound absorbing material, such sound absorbing material is small in size and may be filled into a smaller cavity. This addresses the problem that the acoustic cavity of the speaker is small and may not package the sound absorbing material, and thus accommodates the trend of miniaturization of the speaker.

3. According to the present disclosure, a conflict between moisture absorption and electrostatic field effect is balanced, and suitable synthesis and post-processing are employed to obtain MEL-structural-type molecular sieves which are not apt to absorb moisture and also absorb and desorb an increased amount of air. Therefore, the molecular sieves achieve higher low-frequency improvement performance. A mass ratio of Si to M in the framework is between 150 and 2000, and a content of the extra-framework cations is between 0.05 wt % and 1.5 wt %. In this way, VOCs resistance and performance attenuation resistance of the sound absorbing are remarkably improved, and long-term stability of the sound absorbing material in the speaker box is enhanced.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A sound absorbing material, comprising MEL-structural-type molecular sieves, the MEL-structural-type molecular sieves comprising frameworks and extra-framework cations, the frameworks comprising silica and an oxide MxOy containing an element M which is a non-silicon element; wherein a mass ratio of Si to M in the framework is at least 80, the extra-framework cations comprise at least one of hydrogen ions, alkali metal ions, alkaline earth metal ions and transition metal ions, and a content of the extra-framework cations is between 0.05 wt % and 1.5 wt %.

2. The sound absorbing material according to claim 1, wherein the element M comprises trivalent and/or tetravalent ions.

3. The sound absorbing material according to claim 2, wherein the element M comprises at least one of aluminum, iron, boron, titanium, zirconium, gallium, chromium or molybdenum.

4. The sound absorbing material according to claim 1, wherein a mass ratio of Si to M in the MEL-structural-type molecular sieves is between 150 and 2000.

5. The sound absorbing material according to claim 4, wherein the mass ratio of Si to M in the MEL-structural-type molecular sieves is between 150 and 1500.

6. The sound absorbing material according to claim 5, wherein the mass ratio of Si to M in the MEL-structural-type molecular sieves is between 200 and 1000.

7. The sound absorbing material according to claim 6, wherein a mass ratio of Si to Al in the MEL-structural-type molecular sieves is greater than or equal to 200 and less than 400.

8. The sound absorbing material according to claim 6, wherein a mass ratio of Si to Al in the MEL-structural-type molecular sieves is between 400 and 1000.

9. The sound absorbing material according to claim 1, wherein a particle size of the MEL-structural-type molecular sieves is between 10 nm and 10 μm.

10. The sound absorbing material according to claim 9, wherein the particle size of the MEL-structural-type molecular sieves is between 30 nm and 6 μm.

11. The sound absorbing material according to claim 10, wherein the particle size of the MEL-structural-type molecular sieves is between 40 nm and 5 μm.

12. The sound absorbing material according to claim 11, wherein the particle size of the MEL-structural-type molecular sieves is a 500-nanometer to 5-micrometer conventional synthesis micrometer-scale particle size or a 40-nanometer to 500-nanometer non-conventional synthesis micrometer-scale particle size.

13. The sound absorbing material according to claim 1, wherein the extra-framework cations comprise at least one of lithium ions, sodium ions, potassium ions, barium ions, calcium ions, magnesium ions, copper ions, zinc ions or silver ions.

14. The sound absorbing material according to claim 1, wherein the content of the extra-framework cations is between 0.1 wt % and 1.0 wt %.

15. The sound absorbing material according to claim 14, wherein the content of the extra-framework cations is between 0.15 wt % and 0.8 wt %.

16. The sound absorbing material according to claim 1, wherein the MEL-structural-type molecular sieves comprise pure-phase MEL-structural-type molecular sieves or mixed-phase MEL-structural-type molecular sieves.

17. The sound absorbing material according to claim 1, wherein the MEL-structural-type molecular sieves are molded to shaped particles by adding a binder, the shaped particles having a particle size of between 10 μm and 1000 μm.

18. The sound absorbing material according to claim 17, wherein the particle size of the shaped particles is between 20 nm and 600 μm.

19. The sound absorbing material according to claim 18, wherein the particle size of the shaped particles is between 25 nm and 500 μm.

20. A speaker, comprising: a housing having a receiving space, a sounding unit disposed in the housing and a rear cavity defined by the sounding unit and the housing; wherein the rear cavity is filled with the sound absorbing material as defined in any one of claim 1.
